(19) United States
(12) Patent Application Publication
(10) Pub. No.: US 2005/0144260 A1
(43) Pub. Date: Jun. 30, 2005

(54) Method for setting up point-to-point protocol (PPP) connection between mobile communication terminal and base station

(75) Inventor: Seung-Wook Han, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/897,833

(22) Filed: Jul. 23, 2004

(30) Foreign Application Priority Data
Dec. 26, 2003 (KR) 97572-2003

(51) Int. Cl. G06F 15/16; H04Q 7/24

(52) U.S. Cl. 709/219; 709/245

(57) ABSTRACT

Disclosed is a method for setting up a point-to-point protocol (PPP) connection between a mobile communication terminal and a base station. The mobile communication terminal transmits to the base station an Internet protocol (IP) address assignment request frame using a negotiation frame for an IP address assignment request. The mobile communication terminal receives an IP address assignment frame from the base station in response to the IP address assignment request frame. The mobile communication terminal sets an IP address through the IP address assignment frame, and re-transmits the IP address assignment frame to the base station.

### PRIORITY

This application claims priority to an application entitled “METHOD FOR SETTING UP POINT-TO-POINT PROTOCOL (PPP) CONNECTION BETWEEN MOBILE COMMUNICATION TERMINAL AND BASE STATION”, filed in the Korean Intellectual Property Office on Dec. 26, 2003 and assigned Serial No. 2003-97572, the contents of which are hereby incorporated by reference.

### BACKGROUND OF THE INVENTION

1. Field of the Invention

The present invention relates to an Internet communication method using a mobile communication terminal, and more particularly to a method for performing point-to-point protocol (PPP) setup according to an initial Internet protocol (IP) address assignment process so that the mobile communication terminal can receive an Internet service.

2. Description of the Related Art

Conventionally, a mobile communication terminal is referred to as a portable device capable of providing wireless communication services to users through wireless communication with a base station. The mobile communication terminal has become a necessity for people of all ages and both sexes throughout the world.

The mobile communication terminal enables text message communication, chatting or games as well as voice communication, and enables the viewing of news through wireless Internet connection.

When a mobile communication terminal desires to receive an Internet service, that is, when the mobile communication terminal desires to receive game, song, information search or e-mail service, it uses a point-to-point protocol (PPP). The primary purpose of the PPP enables the mobile communication terminal to receive an IP address from a server (hereinafter, referred to as “base station having an interworking function (IWF)” or “base station (IWF)”) so that the mobile communication terminal can receive the Internet service.

In case of the Internet communication using a conventional computer, an IP address is input and the Internet service is provided through a web browser. The mobile communication terminal can only receive the Internet service when assigned the IP address for the Internet access. The mobile communication terminal must start the PPP for the Internet access so that the IP address can be assigned from the base station (IWF) serving as the server to the mobile communication terminal. Subsequently, the mobile communication terminal can access the Internet through the web browser with the assigned IP address.

The mobile communication terminal for receiving the Internet service employs the same PPP as when a personal computer performs Internet communication based on a transmission control protocol/Internet protocol (TCP/IP) through telephone access. According to the PPP, an IP address is typically assigned to the mobile communication terminal through a sequential three-step algorithm.

The process for assigning the IP address for the mobile communication terminal using the PPP includes a link control protocol (LCP) step, an authentication step and an Internet protocol control protocol (IPCP) step. At the LCP step, a determination is made as to whether or not communication between the mobile communication terminal and the base station is possible, and a communication channel is set up therebetween according to a result of the determination. At the authentication step, the mobile communication terminal sends an authentication request to the base station (IWF) and then the base station (IWF) authenticates the mobile communication terminal. At the IPCP step, the mobile communication terminal requests an IP address for Internet communication, and the base station (IWF) assigns a corresponding IP address to the mobile communication terminal.

As described above, the mobile communication terminal must undergo the above-described three steps or must undergo the LCP step and the IPCP step rather than the authentication step in order to receive the Internet communication service. Consequently, the IPCP step must be completed in order that the conventional mobile communication terminal receives the Internet communication service. Then, the mobile communication terminal can receive an assigned IP address and can receive the Internet service using the IP address.

The communication based on the three steps between the mobile communication terminal and the base station (IWF) for the IP address assignment using the above-described PPP is achieved through negotiation at each step.

FIG. 1 is a flow chart illustrating a method for enabling the conventional mobile communication terminal to receive an assigned IP address.

As shown in FIG. 1, a method for assigning an IP address through communication between a mobile communication terminal 10 and a base station (IWF) 20 includes a link control protocol (LCP) step S10, an authentication step S20 and an Internet protocol control protocol (IPCP) step S30.

In more detail, a communication request is made by negotiation between the mobile communication terminal 10 and the base station (IWF) 20 (S12). At this point, the mobile communication terminal 10 and the base station (IWF) 20 set up a communication channel capable of performing the communication (S14).

When the communication channel between the mobile communication terminal 10 and the base station (IWF) 20 is set up, the mobile communication terminal 10 sends an authentication request to the base station (IWF) 20 (S22). In response to the authentication request, the base station (IWF) 20 authenticates the mobile communication terminal 10 and sends a response signal to the mobile communication terminal 10 (S24).

When the communication channel with the base station (IWF) 20 is set up and the base station (IWF) 20 completes the authentication procedure, the mobile communication terminal 10 sends an IP address request for Internet communication to the base station (IWF) 20 (S32). In response to the IP address request, the base station (IWF) 20 sends IP address assignment failure information to the mobile communication terminal 10 when no IP address is available to be assigned to the mobile communication terminal 10 (S34).

When the mobile communication terminal 10 receives the IP address assignment failure information, an IP address assignment request signal is re-transmitted to the base station (IWF) 20 (S36). The base station (IWF) 20 re-receiving the IP address assignment request signal assigns the IP address to the mobile communication terminal when an IP address is available to be assigned and sends assigned IP address information to the mobile communication terminal 10 (S38).

Subsequently, the mobile communication terminal 10 can perform Internet communication using the IP address assigned from the base station (IWF) 20 (S40).

At each of the three steps for the IP address assignment, negotiation is achieved through a request and a response when the PPP negotiation between the mobile communication terminal 10 and the base station (IWF) 20 is performed.

Signal flow between the mobile communication terminal 10 and the base station (IWF) 20 shown in FIG. 1 shows a simple negotiation process for PPP setup. As shown in FIG. 1, the mobile communication terminal 10 performs PPP setup through a minimum of five transmissions and a minimum of five receptions.

Thus, an IP address is assigned to the mobile communication terminal 10 through communication between the mobile communication terminal 10 and the base station (IWF) 20. Because a negotiation process is required at each step in order to complete a PPP setup process, there is a problem in that a procedure for setting up the PPP is complex.

### SUMMARY OF THE INVENTION

Therefore, the present invention has been made in view of the above and other problems, and it is one object of the present invention to provide a method for setting up a protocol connection of a mobile communication terminal that can quickly set up a point-to-point protocol (PPP) through a minimum transmission and reception process.

It is another object of the present invention to provide a method for setting up a protocol connection of a mobile communication terminal that can easily perform point-to-point protocol (PPP) setup so that an Internet protocol (IP) address can be assigned through communication with a base station having an interworking function (IWF).

In accordance with an aspect of the present invention, the above and other objects can be accomplished by the provision of a method for setting up a point-to-point protocol (PPP) connection between a mobile communication terminal and a base station, comprising the steps of: (a) transmitting, by the mobile communication terminal to the base station, an Internet protocol (IP) address assignment request frame using a negotiation frame for an IP address assignment request; (b) receiving an IP address assignment frame from the base station in response to the IP address assignment request frame; and (c) setting an IP address through the IP address assignment frame, and re-transmitting the IP address assignment frame to the base station.

In accordance with the present invention, only necessary operations for receiving an assigned IP address are performed to reduce unnecessary frame transmission when the PPP is set up between the mobile communication terminal and the base station (IWF). That is, a channel setup process and an authentication process can be omitted, and an IP address assignment request is made using a negotiation frame for PPP setup so that an IP address can be assigned when the PPP setup is performed between the mobile communication terminal and the base station (IWF). Consequently, a procedure for setting up the PPP between the mobile communication terminal and the base station (IWF) can be simplified and a PPP setup time can be reduced.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating a method for enabling the conventional mobile communication terminal to receive an assigned Internet protocol (IP) address;

FIG. 2 shows the format of a frame transmitted and received by point-to-point protocol (PPP) negotiation between the conventional mobile communication terminal and a base station having an interworking function (IWF);

FIG. 3 shows an example of a type field shown in FIG. 2 used at a link control protocol (LCP) step shown in FIG. 1;

FIG. 4 shows an example of a type field shown in FIG. 2 used at an Internet protocol control protocol (IPCP) step shown in FIG. 1;

FIG. 5 shows the format of a new PPP negotiation frame or new IPCP (NIPCP) serving as a negotiation frame used for new PPP setup applied to the present invention;

FIG. 6 shows a value of a type field in a negotiation frame shown in FIG. 5;

FIG. 7 shows a value of an application type field included in the type field shown in FIG. 6;

FIG. 8 is a flow chart illustrating a first embodiment of a method for setting up a PPP between the mobile communication terminal and the base station (IWF) in accordance with the present invention;

FIG. 9 shows the format of an IP address assignment request frame transmitted from the mobile communication terminal to the base station (IWF) when a BREW browser is started;

FIG. 10 shows the format of an IP address assignment frame transmitted from the base station (IWF) in response to the IP address assignment request based on a negotiation frame format shown in FIG. 9;

FIG. 11 shows the format of an IP address assignment frame re-transmitted from the mobile communication terminal to the base station (IWF); and

FIG. 12 is a flow chart illustrating a second embodiment of a method for setting up a PPP between the mobile communication terminal and the base station (IWF) in accordance with the present invention.

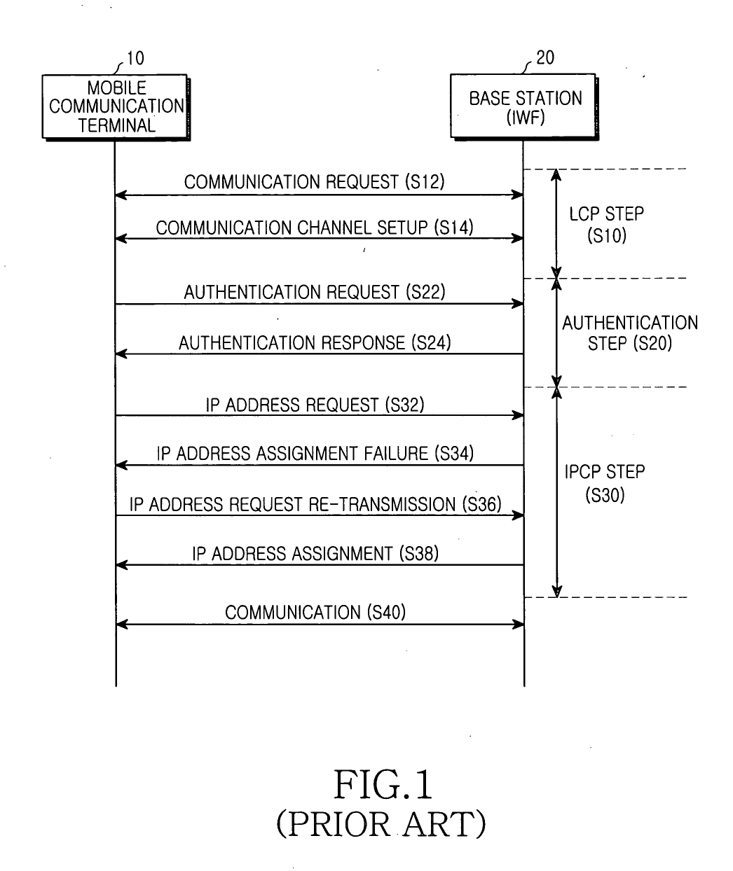

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description made in conjunction with preferred embodiments of the present invention, a variety of specific elements are shown. The description of such elements has been made only for a better understanding of the present invention. Those skilled in the art will appreciate that the present invention can be implemented without using the above-mentioned specific elements. Also, in the following description, a detailed description of known functions and configurations incorporated herein will be omitted when it may obscure the subject matter of the present invention.

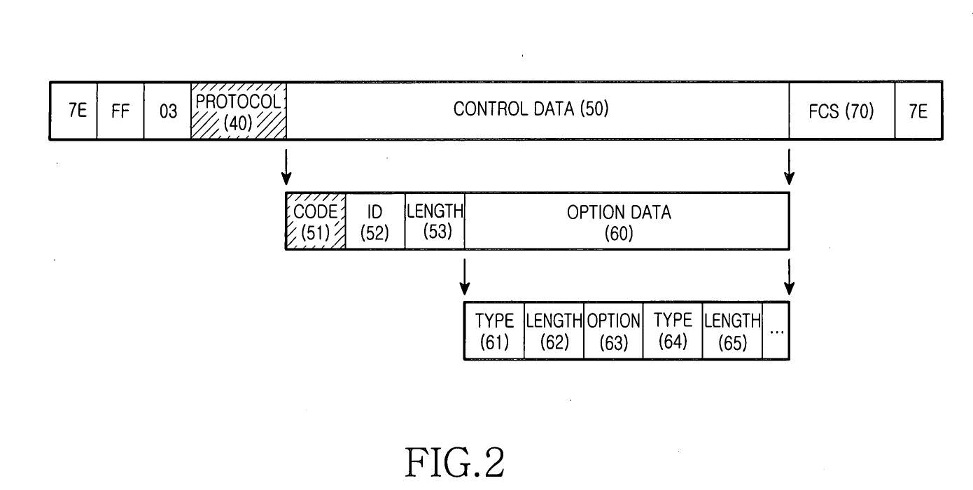

FIG. 2 shows the format of a frame transmitted and received by point-to-point protocol (PPP) negotiation between the conventional mobile communication terminal and a base station having an interworking function (IWF).

As shown in FIG. 2, a data frame includes a protocol field 40, a control data field 50 and a frame check sequence (FCS) field 70.

A protocol field value varies with each communication step between the mobile communication terminal and the base station (IWF). That is, a protocol field value used during a link control protocol (LCP) step is “0xC021”, a protocol field value used during an authentication step is “0xC023” or “0xC223”, and a protocol field value used during an Internet protocol control protocol (IPCP) step is “0x8021”.

The control data field 50 includes a code field 51, an identification (ID) field 52, and a length field 53 and an option data field 60 associated with the control data. Here, a code field value varies with the type of the transmitted data. That is, a code field value used for a corresponding data request is “0x01”, a code field value used for an acknowledgement (ACK) is “0x02”, and a code field value used for a non-acknowledgement (NAK) is “0x03”, etc.

The option data field 60 includes a type field 61, a length field 62, an option field 63, a type field 64 and a length field 65 associated with the option data.

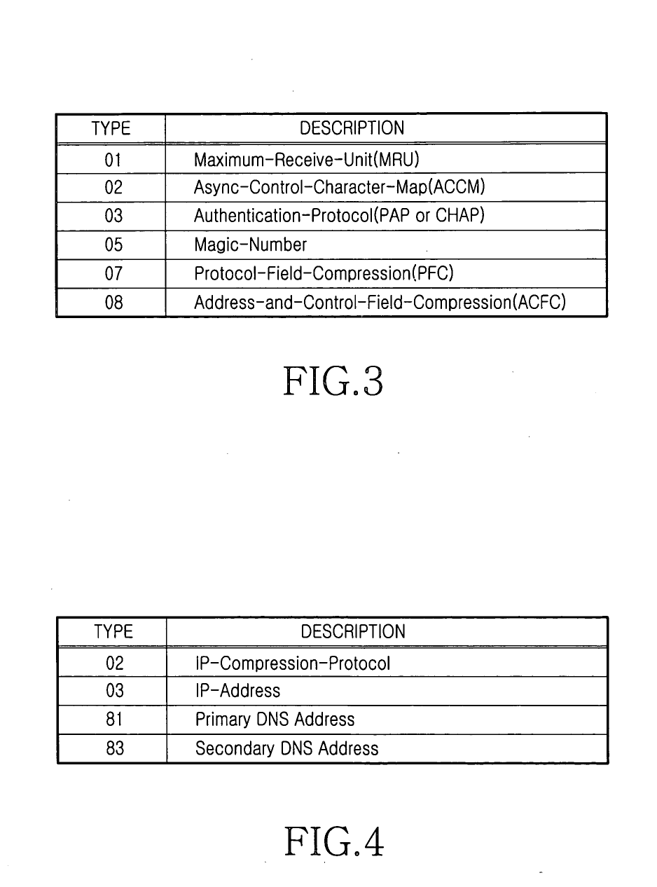

FIG. 3 shows an example of the type field 61 or 64 shown in FIG. 2 used at a link control protocol (LCP) step between the mobile communication terminal and the base station (IWF). FIG. 4 shows an example of the type field 61 or 64 shown in FIG. 2 used at an Internet protocol control protocol (IPCP) step between the mobile communication terminal and the base station (IWF). For reference, no type field value of the option data is present at the authentication step.

The type field value of option data shown in FIGS. 3 and 4 is commonly used between the mobile communication terminal and the base station (IWF) in countries as well as Korea. In this case, values that the mobile communication terminal desires to receive from the base station (IWF) are an IP address, a primary domain name system (DNS) address and a secondary DNS address. The mobile communication terminal receives the values through the negotiation process with the base station (IWF).

The base station (IWF) can additionally send an authentication request to the mobile communication terminal. In this case, the authentication request is not used for authenticating the mobile communication terminal because the call of the code division multiple access (CDMA) terminal has already been authenticated. However, the authentication request made by the base station (IWF) is used for differentiating a fee for a packet service according to an application.

For example, in the case of the Australian communications carrier Telstra, an authentication value is differently required according to a display operation performed by a web browser of the mobile communication terminal, and is differently required according to a CDMA 1x or 2G network coupled to the mobile communication terminal. The Korean communication carrier KTF does not perform an authentication process, and the Korean communication carrier SK Telecom performs the authentication process to determine whether or not the mobile communication terminal is coupled to the CDMA 1x network.

That is, the authentication process is used for differentiating a packet fee according to a state (CDMA 1x or 2G) of the mobile communication terminal, an application driven by the mobile communication terminal according to the base station (IWF), or a communication network connection. An additional type field needs to be defined so that the base station (IWF) can be additionally notified of the information associated with the application or communication network connection.

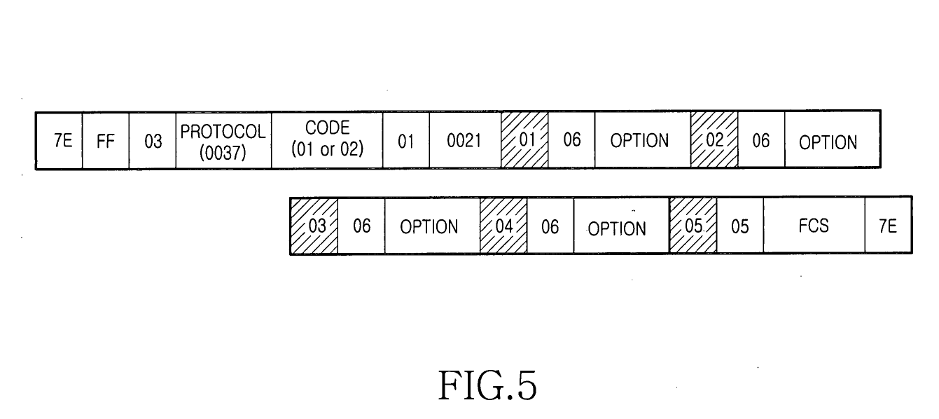

FIG. 5 shows the format of a new PPP negotiation frame serving as a negotiation frame used for new PPP setup applied to the present invention.

A negotiation frame format for PPP setup is basically identical with the existing PPP format except that a new protocol and a new type are added. A value of the new protocol field uses a value selected among the ones which are neither used nor reserved in the Request For Comments (RFC) official standards related to internet technology published by the IETF (Internet Engineering Task Force). It is assumed that the new protocol using the value “0x0037” basically makes negotiation between the mobile communication terminal and the base station (IWF) through the type information corresponding to the LCP step, Authentication step, and IPCP step. However, types using fixed option value are omitted to shorten the message length. In other words, it is assumed that the protocol using the value “0x0037” includes type information corresponding to LCP step and IP compression protocol information indicating a type “0x02” corresponding to the IPCP step. The types of which option values are changed during the negotiation are newly defined when the new protocol is used.

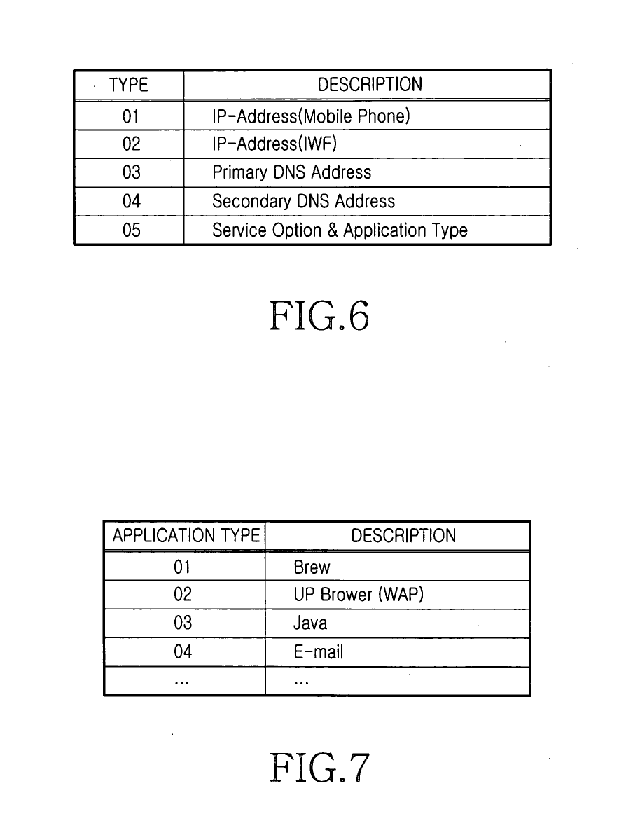

FIG. 6 shows a value of a type field in a negotiation frame used at a new IPCP (NIPCP) step between the mobile communication terminal and the base station (IWF) shown in FIG. 5. Here, type field values “01” to “04” are the same as those used at the existing IPCP step, and a type field value “05” consists of 3 bytes. The type field value “05” consists of 2-byte information indicating a channel service option and a 1-byte information bit indicating an application. Here, the application means an application being currently driven by the mobile communication terminal and the base station (IWF).

FIG. 7 shows a value of an application type field used at a new IPCP (NIPCP) step in the type field of a negotiation frame shown in FIG. 6. As shown in FIG. 7, an application program is set according to a value of the application type field.

For example, when a BREW (Binary Runtime Environment Wireless) application is coupled to the CDMA 1x network according to a service option 33 (0x0021) based on high-speed data transmission at a rate of 153.6 Kbps, a value of the application option field can be indicated by “0x002101” in FIG. 7. In another example, when the application is coupled according to a service option 12 (0x000C) based on quick net connect (QNC) transmission at a rate of 14.4 Kbps, a value of the application option field can be indicated by “0x000C01”.

If a mobile communication terminal or a base station (IWF) not implementing the NIPCP step is present, a corresponding mobile communication terminal or base station (IWF) receiving an application protocol service transmits a protocol reject signal to the other device in a basic operation for PPP setup. Furthermore, the mobile communication terminal or base station (IWF) receiving the application protocol service can perform the existing PPP negotiation without performing a received application operation.

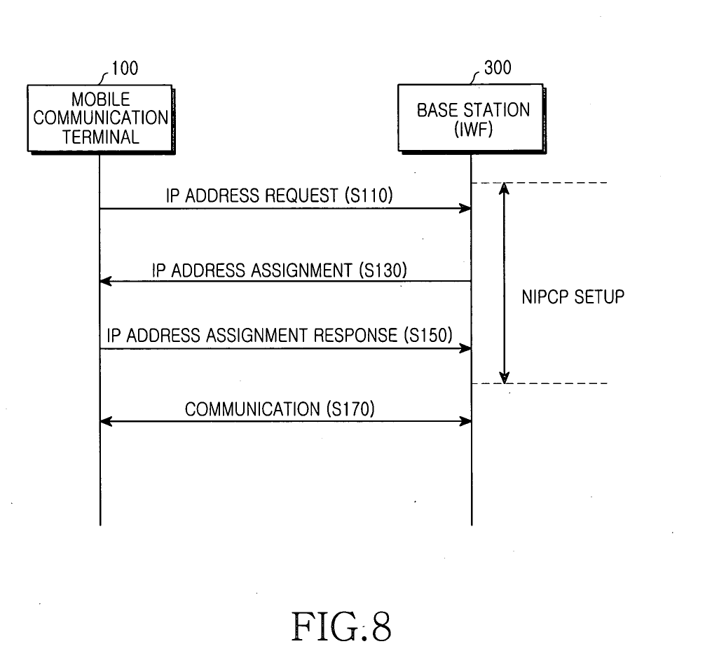

FIG. 8 is a flow chart illustrating a preferred embodiment of a method for setting up a PPP between the mobile communication terminal and the base station (IWF) in accordance with the present invention.

First, the mobile communication terminal 100 transmits an IP address assignment request signal to the base station (IWF) 300 using a message format shown in FIG. 5 (S110). The base station (IWF) 300 assigns an IP address to the mobile communication terminal 100 in response to the IP address assignment request signal and transmits information of the assigned IP address to the mobile communication terminal 100 (S130). The mobile communication terminal 100 receiving the information of the assigned IP address from the base station (IWF) 300 sets the IP address to the received IP address, and re-transmits the assigned IP address to the base station (IWF) 300 (S150). Thus, the mobile communication terminal 100 can perform Internet communication using the assigned IP address (S170).

When the PPP is set up between the mobile communication terminal 100 and the base station (IWF) 300, only the necessary operations for receiving an assigned IP address are performed, which reduces unnecessary frame transmission, such that a procedure for setting up a PPP between the mobile communication terminal 100 and the base station (IWF) 300 can be simplified and a PPP setup time can be reduced.

When a web browser acting as an Internet service program is started in the mobile communication terminal 100, a data frame format used in a process for setting up the PPP between the mobile communication terminal 100 and the base station (IWF) 300 will be described.

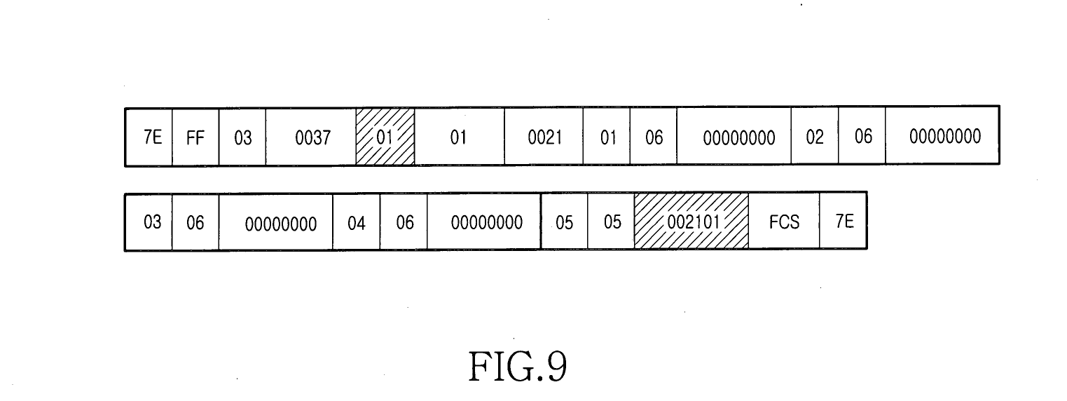

FIG. 9 shows the format of an IP address assignment request frame transmitted to the base station (IWF) 300 by the mobile communication terminal 100 when the BREW browser is started.

As shown in FIG. 9, a value of the frame code field is “01” because the IP address assignment request frame indicates a request signal, and a value of the application type field included in the option field is “0x002101” because a drive program is the BREW browser. These field values can be identified from FIGS. 5 to 7.

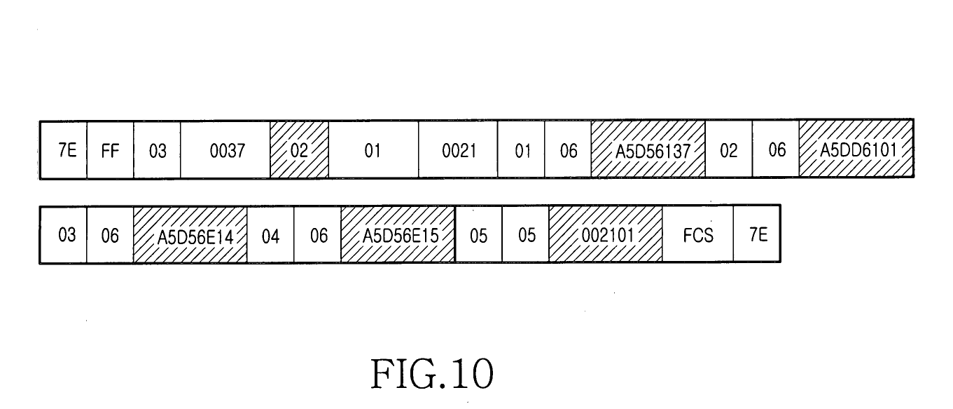

FIG. 10 shows the format of an IP address assignment frame transmitted to the mobile communication terminal 100 by the base station (IWF) 300 in response to the IP address assignment request frame shown in FIG. 9.

In this case, an IP address assigned to the mobile communication terminal 100 by the base station (IWF) 300 is “165.213.97.55”, an IP address of the base station (IWF) 300 is “165.213.97.1”, the primary DNS address is “165.213.110.20” and the secondary DNS address is “165.213.110.21”.

Field values will be described with reference to FIGS. 5 to 7. It can be found that a code field value is “02” because the IP address assignment frame corresponds to an acknowledgement (ACK) signal, and a value of the application type field in the option field is “0x002101” because a drive program is the BREW browser.

Furthermore, a value of the assigned IP address field associated with the mobile communication terminal 100 is “A5D56137” because an IP address assigned to the mobile communication terminal 100 by the base station (IWF) 300 is “165.213.97.55”. A value of the IP address field associated with the base station (IWF) 300 is “A5DD6101” because an IP address of the base station (IWF) 300 is “165.213.97.1”.

The primary DNS address field value is “A5D56E14” because the primary DNS address is “165.213.110.20”, and the secondary DNS address field value is “A5D56E15” because the secondary DNS address is “165.213.110.21”.

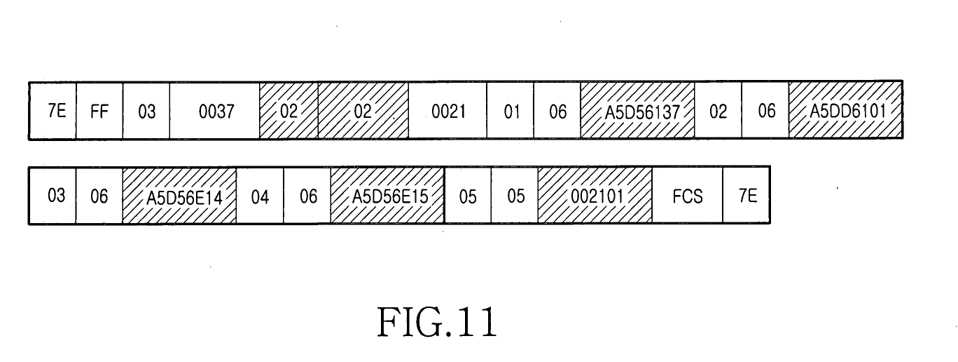

FIG. 11 shows the format of an IP address assignment frame re-transmitted to the base station (IWF) 300 by the mobile communication terminal 100 in response to an IP address assigned to the mobile communication terminal 100 by the base station (IWF) 300 through the frame format shown in FIG. 9.

The frame shown in FIG. 11 is similar to that shown in FIG. 10 because the IP address assignment frame by the base station (IWF) 300 is re-transmitted thereto.

A code field value is “02” because the IP address assignment frame corresponds to an acknowledgement (ACK) signal, and a value of the application type field included in the option field is “0x002101” because a drive program is the BREW browser. Moreover, the assigned IP address field value (A5D56137), the IP address field value (A5DD6101) associated with the base station (IWF) 300, the primary DNS address field value (A5D56E14) and the secondary DNS address field value (A5D56E15) included in the frame to be transmitted from the mobile communication terminal 100 are identical to those of the IP address assignment frame transmitted from the base station (IWF) 300.

The ID field value in the IP address assignment frame re-transmitted by the mobile communication terminal 100 is “02” and is incremented by “01” as compared with that in the IP address assignment frame transmitted by the base station (IWF) 300. The incremented value in the ID field indicates the re-transmission of the frame of the base station (IWF) 300.

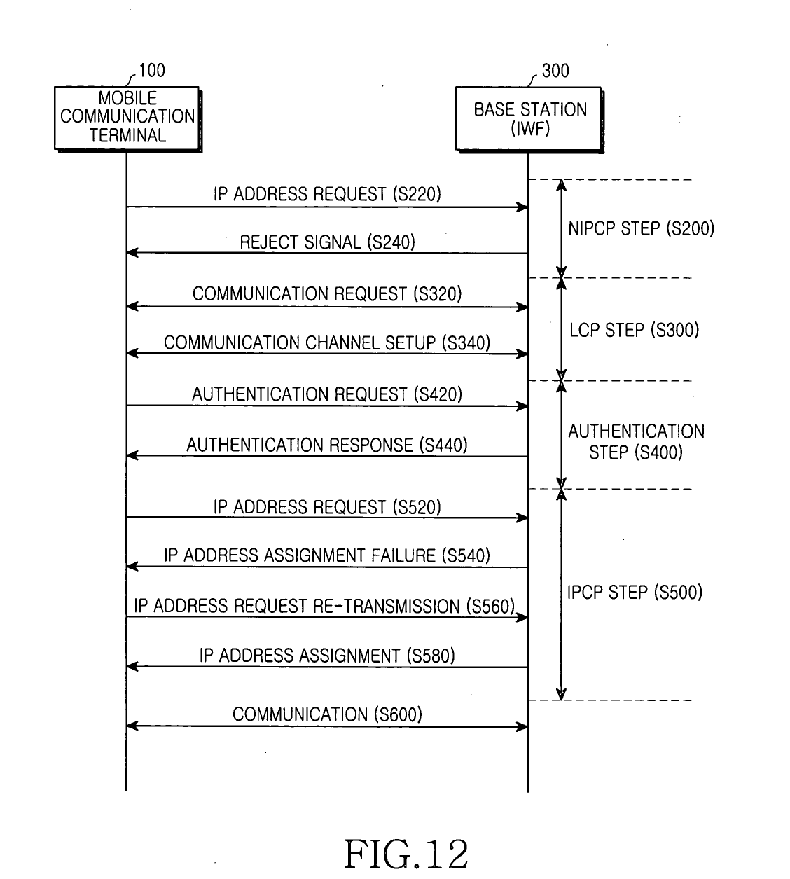

FIG. 12 is a flow chart illustrating a method for setting up a PPP between the mobile communication terminal 100 and the base station (IWF) 300, in the case where the mobile communication terminal 100 can set up the PPP using a protocol frame in accordance with the present invention and the base station (IWF) 300 does not support the PPP setup.

As shown in FIG. 12, the PPP setup method comprises the new Internet protocol control protocol (NIPCP) step S200, a link control protocol (LCP) step S300, an authentication step S400 and an Internet protocol control protocol (IPCP) step S500.

First, the mobile communication terminal 100 transmits the IP address assignment request frame show in FIG. 9 to the base station (IWF) 300 (S220). When the base station (IWF) 300 cannot recognize and analyze the IP address assignment request frame shown in FIG. 9 transmitted from the mobile communication terminal 100, the base station (IWF) 300 transmits a reject signal to the mobile communication terminal 100 (S240).

Upon receiving the reject signal from the base station (IWF) 300, the mobile communication terminal 100 performs a typical operation for PPP setup. The mobile communication terminal 100 and the base station (IWF) 300 exchange a communication request signal (S320). The mobile communication terminal 100 and the base station (IWF) 300 receiving the communication request signal set up a communication channel for communication therebetween (S340).

When the communication channel is set up, the mobile communication terminal 100 transmits an authentication request frame to the base station (IWF) 300 (S420). Upon receiving the authentication request frame, the base station (IWF) 300 authenticates the mobile communication terminal 100 and transmits the response information to the mobile communication terminal 100 (S440).

When the authentication procedure based on the authentication request frame is successful, the mobile communication terminal 100 transmits an IP address assignment request frame to the base station (IWF) 300 (S520). The base station (IWF) 300 receives the IP address assignment request frame and transmits the IP address assignment failure information to the mobile communication terminal 100 when failing to assign an IP address (S540).

Upon receiving the IP address assignment failure information, the mobile communication terminal 100 re-transmits the IP address assignment request frame to the base station (IWF) 300 (S560). When the base station (IWF) 300 can assign the IP address, it assigns the IP address to the mobile communication terminal 100 and transmits the IP address assignment information to the mobile communication terminal 100 (S580).

The mobile communication terminal 100 receiving the IP address assigned by the base station (IWF) 300 sets the IP address to the received IP address, and performs an Internet communication using the set IP address (S600).

Accordingly, when PPP setup is performed between the mobile communication terminal and the base station (IWF), a channel setup process and an authentication process can be omitted, and an IP address assignment request is made using a negotiation frame for the PPP setup so that an IP address can be assigned. Consequently, the PPP setup between the mobile communication terminal and the base station (IWF) can be simplified, and a setup time can be reduced.

In accordance with the present invention, only a necessary operation for receiving an assigned IP address is performed to reduce unnecessary frame transmission when the PPP is set up between the mobile communication terminal and the base station (IWF). Consequently, a procedure for setting up a PPP between the mobile communication terminal and the base station (IWF) can be simplified and a PPP setup time can be reduced.

Moreover, when PPP setup is performed between the mobile communication terminal and the base station (IWF), a channel setup process and an authentication process can be omitted, and an IP address assignment request is made using a negotiation frame for PPP setup so that an IP address can be assigned. Consequently, the PPP setup between the mobile communication terminal and the base station (IWF) can be simplified, and a setup time can be reduced.

Although the preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments, but the present invention is defined by the claims which follow, along with their full scope of equivalents.

1. A method for setting up a point-to-point protocol (PPP) connection between a mobile communication terminal and a base station, comprising the steps of:
(a) transmitting, by the mobile communication terminal to the base station, an Internet protocol (IP) address assignment request frame using a negotiation frame for an IP address assignment request;
(b) receiving an IP address assignment frame from the base station in response to the IP address assignment request frame; and
(c) setting an IP address through the IP address assignment frame, and re-transmitting the IP address assignment frame to the base station.

2. The method according to claim 1, wherein the negotiation frame comprises a protocol field, a code field, an IP address field associated with the mobile communication terminal, an IP address field associated with the base station, a primary domain name system (DNS) address field, a secondary DNS address field, a service option and application type field, and a frame check sequence (FCS) field.

3. The method according to claim 2, wherein the value of the protocol is 0037; the value of the code is 01; and the value of the IP address field associated with the mobile communication terminal, the value of the IP address field associated with the base station, the value of the primary DNS address field, and the value of the secondary DNS address field are each 00000000.

4. The method according to claim 3, wherein the value of the protocol is 0037;
the value of the code is 02; and
the IP address field associated with the mobile communication terminal, the IP address field associated with the base station, the primary DNS address field, and the secondary DNS address field are each assigned by the base station a value corresponding to an IP address.

5. The method according to claim 1, further comprising the steps of:
(d) when a reject signal is received from the base station in response to the IP address assignment request frame at step (b), setting up a communication channel with the base station;
(e) when the communication channel has been set up, sending an authentication request to the base station and receiving a response signal to the authentication request;
(f) when an authentication process has been completed, sending the IP address assignment request to the base station; and
(g) when an IP address has been assigned by the base station, carrying out an IP address setting operation with the assigned IP address for Internet communication.

6. The method according to claim 5, further comprising the step of:
(h) when IP address assignment failure information is received from the base station in response to the IP address assignment request at step (g), re-sending the IP address assignment request to the base station.
